(19) United States
(12) Patent Application Publication
(10) Pub. No.: US 2005/0050506 A1
(43) Pub. Date: Mar. 3, 2005

(54) System and method for determining connectivity of nets in a hierarchical circuit design

(76) Inventors: S. Brandon Keller, Evans, CO (US); Gregory Dennis Rogers, Fort Collins, CO (US); George Harold Robbert, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/647,606

(22) Filed: Aug. 25, 2003

(51) Int. Cl. G06F 17/50

(52) U.S. Cl. 716/12; 716/4

(57) ABSTRACT

A method and system for determining connectivity of a hierarchical circuit design. Hierarchical interface connections in the circuit design are evaluated by determining, for each block instance in each of the hierarchical blocks in the design, whether each port instance, on each block instance, is connected a net in a parent block; and whether each port, in each of the hierarchical blocks, is connected to a net within the block. A warning message is generated upon detection of at least one disconnected net within the hierarchical blocks.

### RELATED APPLICATIONS

The present document contains material related to the material of copending, cofiled, U.S. patent applications Attorney Docket Number 100111221-1, entitled System And Method For Determining Wire Capacitance For A VLSI Circuit; Attorney Docket Number 100111227-1, entitled System And Method For Determining Applicable Configuration Information For Use In Analysis Of A Computer Aided Design; Attorney Docket Number 100111228-1, entitled Systems And Methods Utilizing Fast Analysis Information During Detailed Analysis Of A Circuit Design; Attorney Docket Number 100111230-1, entitled Systems And Methods For Determining Activity Factors Of A Circuit Design; Attorney Docket Number 100111232-1, entitled System And Method For Determining A Highest Level Signal Name In A Hierarchical VLSI Design; Attorney Docket Number 100111234-1, entitled System And Method Analyzing Design Elements In Computer Aided Design Tools; Attorney Docket Number 100111235-1, entitled System And Method For Determining Unmatched Design Elements In A Computer-Automated Design; Attorney Docket Number 100111236-1, entitled Computer Aided Design Systems And Methods With Reduced Memory Utilization; Attorney Docket Number 100111238-1, entitled System And Method For Iteratively Traversing A Hierarchical Circuit Design; Attorney Docket Number 100111257-1, entitled Systems And Methods For Establishing Data Model Consistency Of Computer Aided Design Tools; Attorney Docket Number 100111259-1, entitled Systems And Methods For Identifying Data Sources Associated With A Circuit Design; and Attorney Docket Number 100111260-1, entitled Systems And Methods For Performing Circuit Analysis On A Circuit Design, the disclosures of which are hereby incorporated herein by reference.

### BACKGROUND OF THE INVENTION

E-CAD (electronic computer-aided design) analysis tools often rely on connectivity information when performing analysis of VLSI circuit netlists. In typical VLSI E-CAD analysis tools, net connectivity in a circuit design is determined simultaneously with design analysis. An analysis run is typically lengthy, and a connectivity error that is found while an analysis is in progress generally requires the analysis to be re-run. Some previously existing E-CAD tools perform connectivity checking by tracing each net in the entire design, and reporting errors if the net is terminated abruptly, or if the net does not connect properly to a block (cell) in the design. Tracing each net in a design, particularly in a design such as a typical VLSI processor comprising millions of nets, is undesirably slow.

### SUMMARY OF THE INVENTION

A method is described for determining connectivity of a hierarchical circuit design. Hierarchical interface connections in the circuit design are evaluated by determining, for each block instance in each of the hierarchical blocks in the design, whether each port instance, on each block instance, is connected to a net in a parent block; and whether each port, in each of the hierarchical blocks, is connected to a net within the block. A warning message is generated upon detection of at least one disconnected net within the hierarchical blocks.

### BRIEF DESCRIPTION OF THE DRAWINGS

A more complete understanding hereof may be obtained by reference to the drawings, in which:

FIG. 1 illustrates an exemplary embodiment of a system for determining connectivity of elements in a VLSI design;

FIG. 2 is a flowchart illustrating an exemplary set of steps performed in operation of the system shown in FIG. 1; and

FIG. 3 is a diagram of an exemplary hierarchical design.

### DETAILED DESCRIPTION

Definitions

A net is a single electrical path in a circuit that has the same electrical characteristics at all of its points. Any collection of wires that carries the same signal between circuit components is a net. If the components allow the signal to pass through unaltered (as in the case of a terminal), then the net continues on subsequently connected wires. If, however, the component modifies the signal (as in the case of a transistor or a logic gate), then the net terminates at that component and a new net begins on the other side. Connectivity of components in a VLSI circuit design is typically specified using a netlist, which indicates the specific nets that interconnect the various circuit components.

A significant characteristic of VLSI and other types of circuit design is a reliance on hierarchical description. A primary reason for using hierarchical description is to hide the vast amount of detail in a design. By reducing the distracting detail to a single object that is lower in the hierarchy, one can greatly simplify many E-CAD operations. For example, simulation, verification, design-rule checking, and layout constraints can all benefit from hierarchical representation, which makes them more computationally tractable. Since many circuits are too complicated to be easily considered in their totality, a complete design is often viewed as a collection of component aggregates that are further divided into sub-aggregates in a recursive and hierarchical manner. In VLSI circuit design, these aggregates are commonly referred to as blocks (or cells). The use of a block at a given level of hierarchy is called an ‘instance’. Each block has one or more ‘ports’, each of which provides a connection point between a net within the block and a net external to the block.

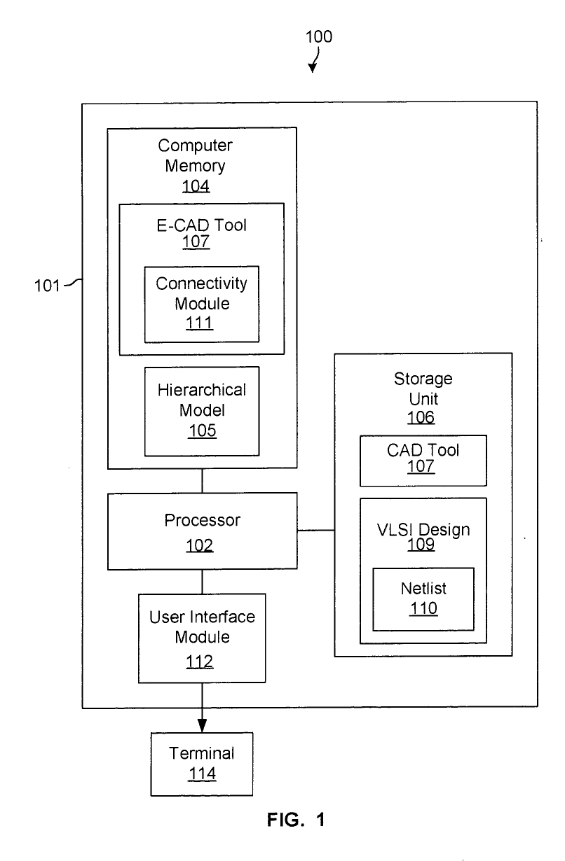

FIG. 1 depicts an exemplary embodiment of a E-CAD (computer automated design) system 100 for determining connectivity of nets in a VLSI circuit design 109. As shown in FIG. 1, E-CAD system 100 includes computer system 101 and E-CAD tool 107. Computer system 101 controls E-CAD tool 107 to analyze design 109. Design 109 is a hierarchical VLSI circuit design that includes a netlist 110 which indicates the specific nets that interconnect components of the design. Computer system 101 includes processor 102, which is coupled to computer memory 104 and storage unit 106. Computer system 101 is configured for traversing connections between hierarchical blocks of design 109 and generating a warning, on a display or printer terminal 114, upon detection of any disconnected nets or ports in the design. E-CAD tool 107 may initially reside in storage unit 106. Upon initialization, at least part of E-CAD tool 107, including connectivity module 111, is loaded into computer memory 104. Design 109, or a portion thereof, including netlist 110, is also loaded in computer memory 104 upon initialization of E-CAD tool 107.

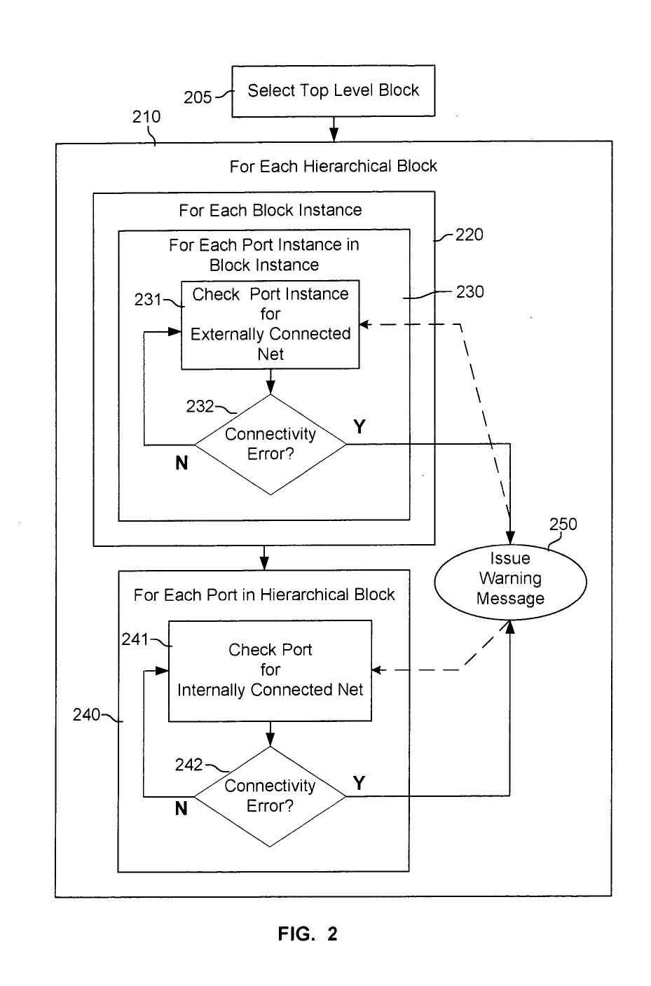

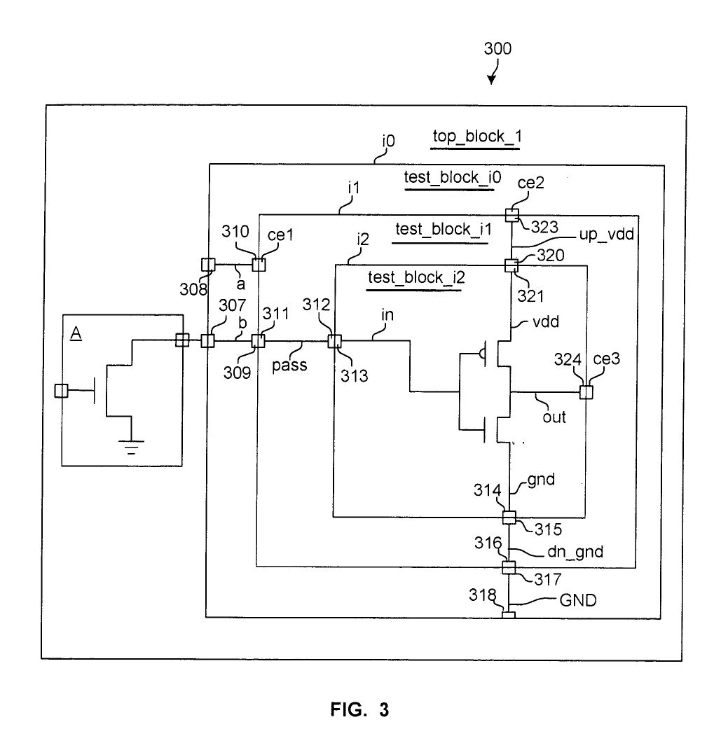

FIG. 2 is a flowchart illustrating an exemplary set of steps performed in operation of system 100. As shown in FIG. 2, connectivity module 111 traverses interface connections of hierarchical blocks of hierarchical VLSI circuit design 109 to determine whether the circuit design contains proper connectivity. Although in actual operation, system 100 uses information contained in netlist 110 to make this determination, system operation is explained herein by visual reference to the exemplary circuit design 300 shown in FIG. 3, which is a diagram of an exemplary hierarchical design 300, such as design 109 of FIG. 1.

As shown in FIG. 3, design 300 includes hierarchically related blocks top_block_{—}1, test_block_i0, test_block_i1, and test_block_i2. Hierarchical block top_block_{—}1 includes instantiation block, or block instance, i1. Instance i1, when viewed from the perspective of a top level in the sub-hierarchy represented by test_block_i1 and test_block_i2, is itself considered to be a block, i.e., test_block_i1, in that particular hierarchical context. In the same context, the block test_block_μl contains instance i2, which, if considered from a perspective internal to the ‘box’ (i2/test_block_i2) shown in FIG. 3, would be referred to as block test_block_i2. It can thus be seen that the definitions of ‘block’ and block ‘instance’ respectively depend on whether a particular ‘box’ (a block or instance of the block) is viewed from an internal or external standpoint, i.e., the appropriate nomenclature depends on the hierarchical perspective from which the ‘box’ is viewed. Each ‘box’ (block or instance) has a plurality of ‘ports’ and corresponding port instances (‘portinsts’), each pair of which provides a connection point between a net within the block and a net external to the block. A ‘port/portinst’ thus comprises two contiguous parts, a first part, termed a ‘portinst’, which is a port instance located externally on a box (or instance) boundary; and a second part, termed a ‘port’, which is located internally on the box (or block) boundary.

As can be seen from FIG. 3, portinsts are the half of the ‘port/portinst’ on the outside of a ‘box’ (for example, item 310), and ports are the half of the ‘port/portinst’ on the inside of a ‘box’ (e.g., item 311). In one embodiment, a port takes the same name as the net to which it is connected, and port instances have the same name as their describing port. When examining a netlist, such as netlist 110, portinst 312 in design 300 may be described in the netlist as ‘net pass->port inst in’ in the block test_block_i1. This netlist entry indicates that the net ‘pass’ connects to the portinst ‘in’ 312 on instance ‘i2.’ The corresponding port in test_block_i2 is port 313, which has the name ‘in’, since it is connected to net ‘in’ in test_block_i2. In an exemplary embodiment, a hierarchical model 105 as shown in FIG. 1 stored in computer memory 104 is used to represent the hierarchy of design 300, and the difference between a portinst and a port can be readily determined through the use of an object-oriented system in which the two entities are different objects and are owned by different types of objects. In an exemplary embodiment employing an object-oriented software system, block instances own portinsts, and blocks own ports.

At step 205, connectivity module 111 selects a top level block of hierarchical VLSI design 300 and recursively analyzes each port/portinst within the block to determine connectivity between the nets in the design. In step 210, each of the steps in sections 220 and 240 is performed for each hierarchical block of interest in design 300. In section 220, for each block instance in a particular hierarchical block, the steps in section 230 are performed for each port instance (portinst) in that block instance. In section 230, at step 231, a port instance is checked for the presence of a net externally connected to the block instance. If a connectivity error is found (step 232), then a warning message, indicating the name of the ‘disconnected’ port instance, is generated by user interface module 112, at step 250.

In section 240, for each port in each hierarchical block presently being analyzed, the port is checked for the presence of a net internally connected to the block. If a connectivity error is found (step 242), then a warning message, indicating the name of the ‘disconnected’ port, is generated by user interface module 112, at step 250.

In an exemplary embodiment, operation of system 100 determines connectivity of design 300 in a manner consistent with algorithm A, shown below, which corresponds to the steps shown in the FIG. 2 flowchart:

Algorithm A

for each hierarchical block B {

for each instance Bi in block B {

for each port instance pi on instance Bi {

if (pi not connected to a net in parent block B) {

report error

}

}

}
for each port P in block B {

if (port P not connected to a net within block B) {

report error

}

}

}

System 100 executes the above algorithm, in part, on a portion of design 300, in accordance with the steps shown in the FIG. 2 flowchart, as follows:
1 for each hierarchical block
2. for each instance ‘i’ in the block
3. for each port instance ‘pi’ on instance ‘i’
4. if pi not connected to net in parent block,
5. report error
6. for each port P in hierarchical block
7. if P not connected to net within the block,
8. report error

Lines 2-5 above are first performed for block instance i1 port instances 309, 310, ce2, and 317, as follows. Note that actual port and portinst names have been omitted, with reference numbers being substituted in their stead:
check port instance 309 on instance i1:
   port instance 309 is connected to net ‘b’ in test_block_i0;
check port instance 310 on instance i1:
   port instance 310 is connected to net ‘a’ in test_block_i0;
check port instance ce2 on instance i1:
   port instance ce2 is not connected to a net in test_block_i0;
   report error;
check port instance 317 on instance i1:
   port instance 317 is connected to net ‘GND’ in test_block_i0.

Next, lines 2-5 above are then performed for block instance i2 port instances 312, 320, ce3, and 315, as follows:
check port instance 312 on instance i2:
   port instance 312 is connected to net ‘pass’ in test_block_i1;
check port instance 320 on instance i2:
   port instance 320 is connected to net ‘up_vdd’ in test_block_μl;
check port instance ce3 on instance i2:
   port instance ce3 is not connected to a net in test_block_i1;
      report error;
check port instance 315 on instance i2:
   port instance 315 is connected to net ‘dn_gnd’ in test_block_i1.

Next, lines 6-8 of the above algorithm are performed for each port in test_block_i0, as follows:
check port 307:
   port 307 connected to net ‘b’ within test_block_i0;
check port 308:
   port 308 connected to net ‘a’ within test_block_i0;
check port 318:
   port 318 connected to net ‘GND’ within test_block_i0;

Next, lines 6-8 of the above algorithm are performed for each port in test_block_μl, as follows:
check port 311:
   port 311 connected to net ‘pass’ within test_block_i1;
check port ce1:
   port ce1 not connected to a net within test_block_μl;
      report error;
check port 323:
   port connected to net ‘up_vdd’ within test_block_i1;
check port 316:
   port connected to net ‘dn_gnd’ within test_block_μl;

Finally, lines 6-8 of the above algorithm are performed for each port in test_block_i2, as follows:
check port 313:
   port 313 connected to net ‘in’ within test_block_i2;
check port 321:
   port 321 connected to net ‘vdd’ within test_block_i2;
check port 324:
   port connected to net ‘out’ within the test_block_i2;
check port 314:
   port connected to net ‘gnd’ within test_block_i2;

After the above checks have been made, it can be seen that there are three connectivity errors in design 300: port instances ‘ce2’and ‘ce3’ (on block instances i1 and i2, respectively) do not connect to nets in parent blocks test_block_i0 and test_block_i1, respectively; and port ‘ce1’ constitutes a connectivity error because this port on block ‘test_block_i1’ does not have a connected net within the block. Connectivity module 111 therefore generates a warning upon detection of one or more disconnected nets, and transmits the warning to user interface module 112 for display or printing via user terminal 114, and/or to storage unit 106 for storage, in step 250. The warning includes the name of the disconnected port or port instance.

Instructions that perform the operation discussed with respect to FIG. 2 may be stored on computer-readable storage media. These instructions may be retrieved and executed by a processor, such as processor 102 of FIG. 1, to direct the processor to operate in accordance with the present system. The instructions may also be stored in firmware. Examples of storage media include memory devices, tapes, disks, integrated circuits, and servers.

Certain changes may be made in the above methods and systems without departing from the scope of the present system. It is to be noted that all matter contained in the above description or shown in the accompanying drawings is to be interpreted as illustrative and not in a limiting sense. For example, the items shown in FIG. 1 may be constructed, connected, arranged, and/or combined in other configurations, and the set of steps illustrated in FIG. 2 may be performed in a different order than shown without departing from the spirit of the present method and system.

1. A method for determining connectivity of a hierarchical circuit design, comprising steps of:
traversing hierarchical interface connections in a plurality of hierarchical blocks in at least a part of the circuit design by performing steps, for each block instance in each hierarchical block in the design, including:
for each port instance on said each block instance, wherein the port instance is not connected to a net in a parent block, generating a warning indicating the name of the port instance that is not connected; and
for each port, in each of the hierarchical blocks, that is not connected to a net within the block, generating a warning indicating the name of the port that is not connected.

2. The method of claim 1, wherein the traversing step is performed prior to an analysis of the circuit design.

3. The method of claim 1, wherein the warning comprises a message transmitted to a user terminal.

4. The method of claim 1, wherein a top hierarchical level of one of the hierarchical blocks is selected as an initial hierarchical block in the traversing step.

5. A method for determining connectivity in a plurality of hierarchical blocks of a hierarchical circuit design, comprising steps of:
traversing hierarchical interface connections of the hierarchical blocks,
wherein a top hierarchical level of one of the hierarchical blocks is selected as an initial hierarchical block, by performing steps,
for each block instance in each hierarchical block in at least a part of the design, including:
for each port instance on said each block instance, wherein the port instance is not connected a net in a parent block, generating a warning indicating the name of the port instance that is not connected; and
for each port, in each of the hierarchical blocks, that is not connected to a net within the block, generating a warning indicating the name of the port that is not connected;
wherein the warning comprises a message transmitted to a user terminal.

6. The method of claim 5, wherein the traversing step is performed prior to an analysis of the circuit design.

7. A method for determining connectivity of a hierarchical circuit design, comprising steps of:
evaluating hierarchical interface connections of the design by determining, for each block instance in each of the hierarchical blocks in the design:
whether each port instance, on said each block instance, is connected a net in a parent block; and
whether each port, in each of the hierarchical blocks, is connected to a net within the block; and
generating a warning upon detection of at least one disconnected said net within the hierarchical blocks.

8. The method of claim 7, wherein the warning comprises a message transmitted to a user terminal.

9. The method of claim 7, wherein a top hierarchical level of one of the hierarchical blocks is selected as an initial hierarchical block in the evaluating step.

10. A system for determining connectivity of a hierarchical circuit design, comprising:
a processor;
a connectivity module, executable by the processor to evaluate hierarchical interface connections between hierarchical blocks in the circuit design;
a user interface module, coupled to the processor, for generating a warning upon detection of at least one disconnected net within the hierarchical blocks;
wherein the connectivity module evaluates hierarchical interface connections of the design by determining, for each block instance in each of the hierarchical blocks in the design:
whether each port instance, on said each block instance, is connected a net in a parent block, wherein a warning, indicating the name of each said port instance that is not connected, is generated by the user interface module; and
whether each port, in each of the hierarchical blocks, is connected to a net within the block, wherein a warning, indicating the name of each said port that is not connected, is generated by the user interface module.

11. The system of claim 10, further including a storage unit, accessible to the processor, in which the circuit design is stored is stored.

12. The system of claim 10, wherein a hierarchical model of the circuit design, accessible by the connectivity module via the processor, is used to indicate the hierarchical interface connections between hierarchical blocks in the circuit design.

13. A system for determining connectivity of a hierarchical circuit design, comprising:
means for evaluating hierarchical interface connections of the design by determining, for each block instance in each of the hierarchical blocks in the design:
whether each port instance, on said each block instance, is connected to a net in a parent block; and
whether each port, in each of the hierarchical blocks, is connected to a net within the block; and
means for generating a warning upon detection of at least one disconnected said net within the hierarchical blocks.

14. The system of claim 13, wherein a top hierarchical level one of the hierarchical blocks is selected as an initial hierarchical block used by said evaluating means.

15. The system of claim 13, wherein the warning comprises a message transmitted to a user terminal.

16. The system of claim 13, wherein the hierarchical interface connections are evaluated prior to an analysis of the circuit design.

17. A software product comprising instructions, stored on computer-readable media, wherein the instructions, when executed by a computer, perform steps for determining connectivity of a hierarchical circuit design, comprising:
evaluating hierarchical interface connections of the design by determining, for each block instance in each of the hierarchical blocks in the design:
whether each port instance, on said each block instance, is connected to a net in a parent block; and
whether each port, in each of the hierarchical blocks, is connected to a net within the block; and
generating a warning upon detection of at least one disconnected said net within the hierarchical blocks.
